(19) United States
(12) Patent Application Publication
(10) Pub. No.: US 2004/0172156 A1
(43) Pub. Date: Sep. 2, 2004

(54) Methods and apparatus to perform hybrid binding

(76) Inventor: Chris Brown, Forest, VA (US)

Correspondence Address: GROSSMAN & FLIGHT LLC, Suite 4220, 20 North Wacker Drive, Chicago, IL, 60606-6357, US

(21) Appl. No.: 10/648,503

(22) Filed: Aug. 26, 2003

Related U.S. Application Data
(60) Provisional application No. 60/450,613, filed on Feb. 27, 2003.

(51) Int. Cl. G06F 7/00

(52) U.S. Cl. 700/220

(57) ABSTRACT

Methods and apparatus of assembling a mailing are disclosed. According to one example, the method includes producing a stream of primary books on a production line, determining that a secondary book is to be inserted between first and second primary books on the production line, and creating a space between first and second primary books on the production line. The example method further includes inserting the secondary book into the space between the first and second primary books on the production line.

### CROSS REFERNCES TO RELATED APPLICATIONS

This application claims the benefit of U.S. Provisional Application No. 60/450,613, filed Feb. 27, 2003.

### TECHNICAL FIELD

The present disclosure pertains to printing systems and, more particularly to methods and apparatus to perform hybrid binding.

### BACKGROUND

When bulk mailings are made, significant discounts may be obtained by addressing the items to be mailed in a particular order. For example, postal discounts may be obtained by grouping all mailings destined for a particular zip code or, more generally, mailings destined for the same geographic area. Bulk mailers have long recognized the postage discounts associated with organized mailing and have typically personalized mailings so that as the mailings emerge from a printing line, the mailings are presorted.

As the bulk mailing industry has become more sophisticated, many mailers have opted to send a variety of different mailings to potential customers. The different mailing may include catalogs, flyers, etc. that have different physical configurations. For example, some mailings may include different binding styles, trim sizes, or thickness variations. Historically, however, mailings of different physical configurations are produced in separate mailstreams due to equipment limitations. For example, a catalog of significant thickness may not be processed on the equipment handling a mailstream of flyers of slight thickness. The necessity of using separate mailstreams based on equipment limitations results in the loss of bulk mailing discounts that may exceed, for example, $60 per thousand pieces mailed.

Co-mailing has been used to obtain postal discounts by bundling the mailing pieces of different physical configurations. Co-mailing is an off line process in which two or more complete books (e.g., catalogs, flyers, etc.) are merged together at a piece of equipment called a co-mailer. As will be readily appreciated, the need to transport completed books from two different sources to a co-mailer increases cycle time and adds production costs.

### BRIEF DESCRIPTION OF THE DRAWINGS

FIG. 1 is a diagram of an example book making system.

FIG. 2 is a flow diagram of an example book making process that may be carried out by the controller of FIG. 1.

FIG. 3 is a flow diagram showing additional detail of an example gathering process of FIG. 2.

FIG. 4 is a flow diagram showing additional detail of an example stitching process of FIG. 2.

FIG. 5 is a flow diagram showing additional detail of an example trimming process of FIG. 2.

FIG. 6 is a flow diagram showing additional detail of an example secondary book feeding process of FIG. 2.

FIG. 7 is a flow diagram showing additional detail of an example personalization process of FIG. 2.

FIG. 8 is a flow diagram showing additional detail of an example bundling process of FIG. 2.

### DETAILED DESCRIPTION

Although the following discloses example systems including, among other components, software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the following describes example systems, persons of ordinary skill in the art will readily appreciate that the examples are not the only way to implement such systems.

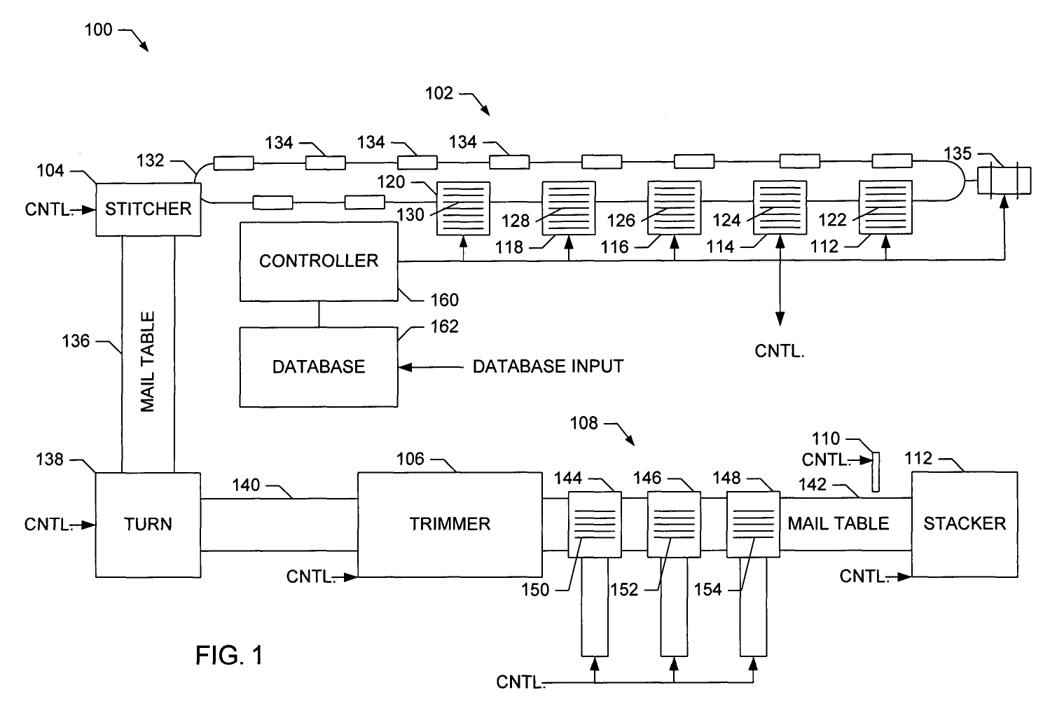

As shown in FIG. 1, an example book making system 100 generally includes a gathering section 102 that feeds gathered signatures to a stitcher 104, which stitches the gathered signatures into primary books. From the stitcher 104, the primary books are routed to a trimmer 106 that trims the edges of the signatures that form the primary books. Collectively, the gathering section 102, the stitcher 104 and the trimmer 106 form a primary book source.

After trimming, the primary books pass a secondary book feeder 108 (i.e., a secondary book source) where secondary books are selectively commingled with the primary books. The secondary books handled by the secondary book feeder 108 are, in the example of FIG. 1, preprinted and bound books that may be perfect bound, saddle stitched or bound in any other desirable way. The secondary books are provided to the secondary book feeder 108 via pallet or conveyor line.

After the books from the primary and secondary sources are commingled at the secondary book feeder 108, the books are personalized or addressed by a printer 110 and passed to a stacker 112. The stacker 112 bundles the primary and secondary books to obtain postal service discounts based on bundled mailings that are destined to the same general geographic location. Additionally, books from the secondary source can be commingled with pre-addressed messaging already applied to the secondary books in a separate operation.

In particular, the gathering section 102 includes a number of pockets 112-120 above which a number of signatures 122-130 are disposed. Although only five example pockets are shown in FIG. 1, the gathering section 102 may include any number of pockets, such as, for example, 18 pockets. A saddle chain 132 having a number of saddles, three of which are shown in FIG. 1 at reference numeral 134, disposed thereon passes under the pockets 112-120. Collectively, the saddle chain 132 and the saddles 134 may be referred to as a line. Generally, in operation, each of the pockets 112-120 opens its respective signature (e.g., 122-130) and deposits the same on a saddle 134 of the saddle chain 132. A motor 135 or other drive mechanism is provided to advance the saddle chain 132. As the saddles 134 advance under the pockets 112-120, the signatures 122-130 are gathered into books. For example, the first signature 122 forms the middle two sheets of, for example, a magazine. The second signature 124 forms the second sheets from the middle, and so on until the last signature 130 is placed onto a saddle 134 as the front and rear cover of the magazine.

While the foregoing generally describes the operation of the gathering section 102, as described below, the gathering section 102 is controlled to selectively leave saddles 134 free from signatures to create gaps in the line of gathered books. These gaps in the line of gathered books are perpetuated throughout the entire system until the gaps reach the secondary book feeder 108, which inserts one or more completed secondary books into the gap in the line.

The gathered books are passed from the gathering section 102 to the stitcher 104 where, for example, the spines of the books are stapled. The output of the stitcher 104 passes to a first mail table 136. The mail table 136 is segmented, for example, in 15 inch increments and the primary books output from the stitcher 104 are filled into the segments of the mail table. As described below, when no book is provided to the stitcher 104 by the gathering section 102, the mail table 136 is advanced nonetheless, thereby leaving a gap in the line for a secondary book to be inserted at a later point in the system 100.

The mail table 136 feeds a turn 138 that joins the mail table 136 and a conveyor 140 at approximately a right angle. As noted previously, the mail table 136 includes gaps for secondary books 150-154 to be later deposited, this spacing is maintained by the turn 138. Accordingly, the conveyor 140 is advanced whether or not the turn 138 passes a book to the conveyor 140.

The conveyor 140 feeds the trimmer 106, which, as described above, trims the edges of the books provided thereto. Due to the spacing allotted for secondary books on the conveyor 140, the trimmer 106 will not always receive a book for trimming. Accordingly, the trimmer 106 will not always need to actuate. The output of the trimmer 106 which, in some cases, is a trimmed book and nothing in other cases, is passed to a second mail table 142.

As with the mail table 136, the second mail table 142, prior to the secondary book feeder 108, includes gaps for secondary books 150-154. The secondary book feeder 108 includes a number of secondary feeders, three of which are shown at reference numbers 144-148 and contain secondary books 150-154, respectively. As described in further detail below, when a space in the mail table 142 is disposed under one of the secondary feeders 144-148, the secondary feeder over the space in the mail table 142 is selectively actuated to deposit a secondary book into the empty space on the mail table 142.

After the secondary books are deposited, the mail table 142 passes the primary and secondary books by the printer 110 that may address or otherwise customize or personalize any or all of the books (either primary or secondary) on the mail table 142. The books that have been personalized are provided to the stacker 112 that bundles the books to receive available mailing discounts.

In practice the foregoing-described gathering section 102, stitcher 104, trimmer 106 and stacker 112 may be implemented using a system available from Müller Martini, Ltd., under the model name of Tempo. However, as will be readily appreciated by those having ordinary skill in the art, gathering, stitching, trimming and stacking systems are commercially available from other sources, such as, for example, Heidelberg and McCain. Additionally, the secondary feeders 144-148 are commercially available from Buhrs®. In one example, the secondary feeders 144-148 are implemented using the Buhrs® 4000 system.

While the foregoing has addressed the components of the system 100 germane to paper, signature and book handling and has generally outlined the operation of the system, the following is pertinent to control aspects of the system 100. In particular, the system 100 includes a controller 160 having an associated database 162. In the example of FIG. 1, the controller 160 may be implemented using a Maverick controller model Video Jet VIP 9500 binding line control system. In the alternative, the controller 160 could be any processing unit, such as a microprocessor, a microcontroller, a programmable logic controller (PLC) or any other suitable logic device. The controller 160 may include memory into which machine executable instructions implementing one or more control routines may be stored. The controller 162 is interfaced to, and controls the pockets 112-120, the motor 135, the stitcher 104, the turn 138, the trimmer 106, the secondary feeders 144-148, the printer 110 and the stacker 112.

The database 162, which may be implemented as any suitable machine-readable media, receives name and address information for addressees and also includes an indication as to whether a particular addressee is to receive a book from the primary or secondary feeding device. The information in the database 162 dictates how the controller 160 will control the various components of the system 100.

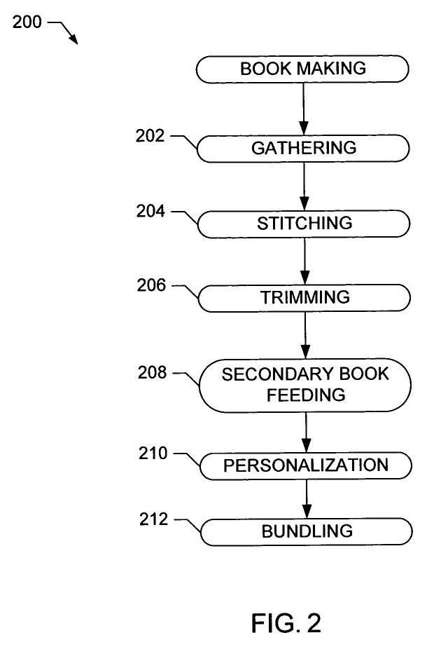

Turning to FIG. 2, an example book making process 200 carried out by the controller 160 is shown as including a gather process 202, a stitching process 204, a trimming process 206, a secondary book feeding process 208, a personalization process 210 and a bundling process 212. When the system 100 is operating, each of the processes 202-212 may occur in parallel. However, the following description refers to the processes 202-212 being sequential for ease of understanding.

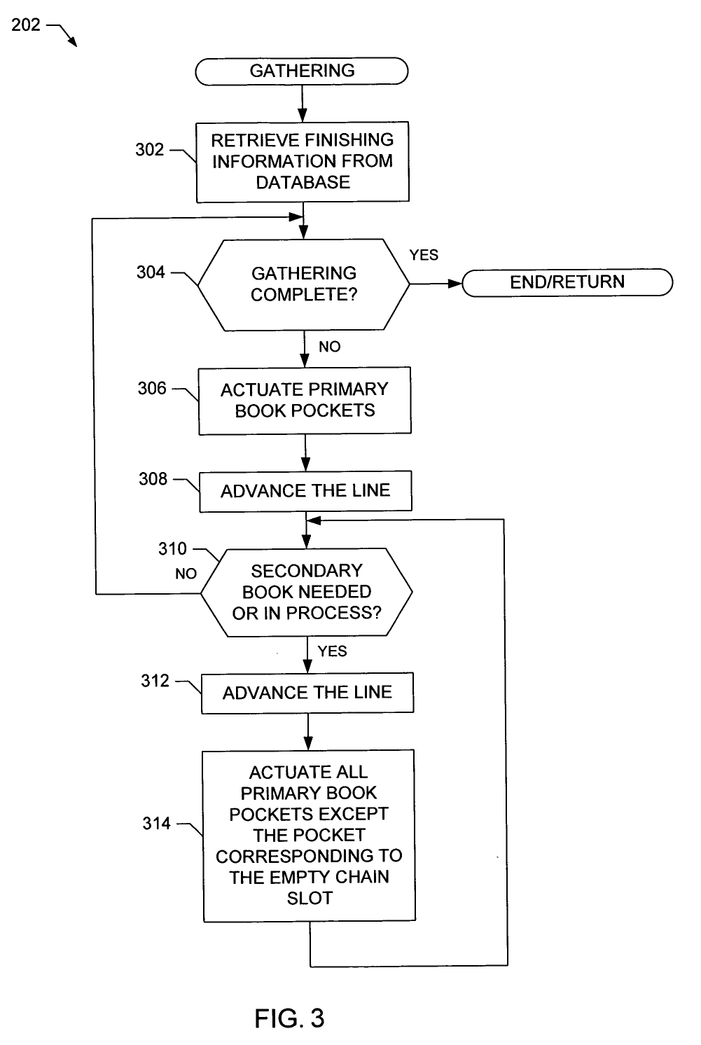

As shown in FIG. 3, an example gathering process 202 begins by the controller 160 retrieving finishing information from the database 162 (block 302). The finishing information may include a series of addressees to receive books, their mailing addresses and an indication of whether a particular addressee is to receive a book from the primary and/or secondary feeding device.

It is then determined if the gathering stage is complete (block 304). If the gathering stage is complete (block 304), the process 202 ends and control returns to the book making process 200. If the gathering is not complete (block 304), the primary pockets 112-120 are actuated (block 306) and the line is advanced (block 308).

It is then determined if a secondary book is needed to accompany any of the primary books being gathered (block 310). If no secondary book is needed (i.e., none of the addressees for which the gathering section 102 is gathering a primary book are to receive a secondary book), it is again determined if the gathering process is complete (block 304). If, however, a secondary book is needed (block 310), the line 132 is advanced (block 312). The advancing of the line without the actuation of the pockets 112-120 results in an empty saddle 134 on the line 132 under the second pocket 114. After the line is advanced (block 312), all primary pockets except the pocket corresponding to the empty saddle 134 (in this example, all pockets except the pocket 114) are actuated (block 314). After the pockets are actuated (block 314), it is again determined if a secondary book is needed or in process (block 310). In the running example, because a secondary book is in process, the blocks 310-314 iterate until the saddle 314 having no signatures thereon emerges from under the last pocket 120. As signatures are gathered to make books, empty saddles 134 are left as placeholders for the secondary book feeder 108 to commingle books for the addressees.

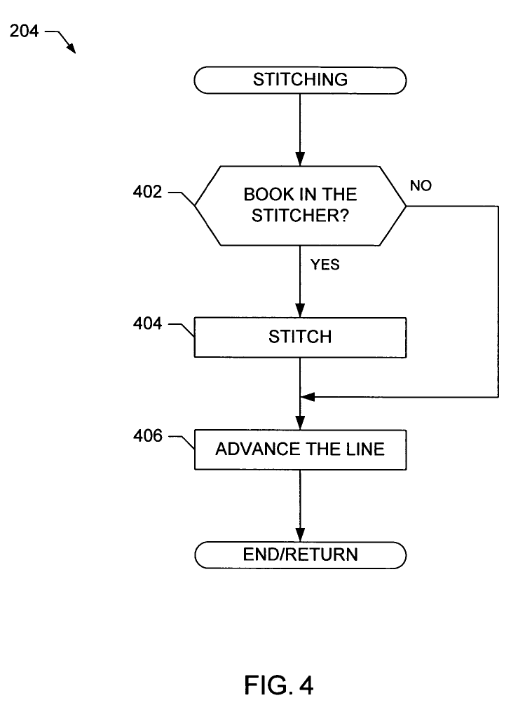

At some point, it will be determined that gathering is complete (block 304) and control will return to the book making process 200, which continues execution at the stitching process 204, shown in detail in FIG. 4. The stitching process 204 begins by determining if there is a book in the stitcher 104 (block 402). If there is a book in the stitcher 104, the book is stitched (block 404) and the line is advanced (block 406). Alternatively, if there is no book in the stitcher 104 (i.e., an empty place on the line intended for a secondary book has reached the stitcher 104), the line is advanced (block 406). After the line is advanced (block 406), the stitching process 204 returns control to the book making process 200, which continues operation at the trimming process 206.

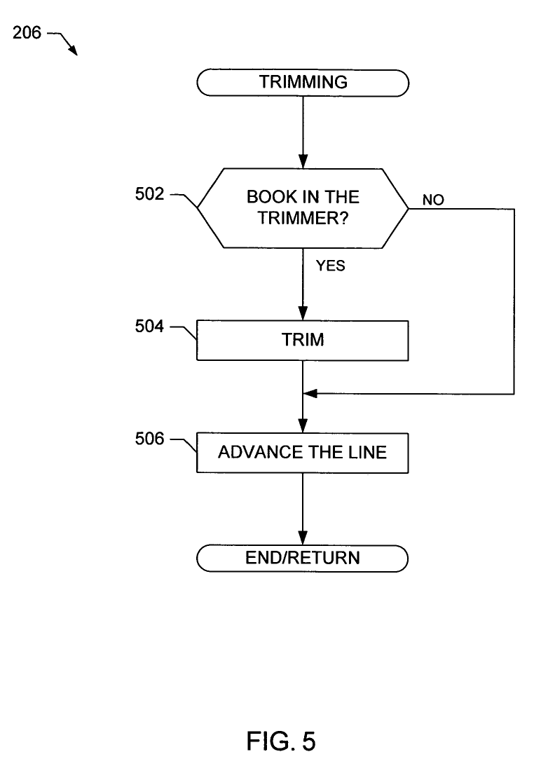

The trimming process 206, as shown in FIG. 5, begins by determining if a book is in the trimmer 106 (block 502). If there is a book in the trimmer 106 (block 502), the book is trimmed (block 504) and the line is advanced (block 506). Alternatively, if a vacant position in the line has reached the trimmer 106 and the trimmer 106 is empty (block 502), the line is advanced (block 506), without the actuation of the trimmer 106. After the line is advanced (block 506), the secondary book feeding process 208 is carried out.

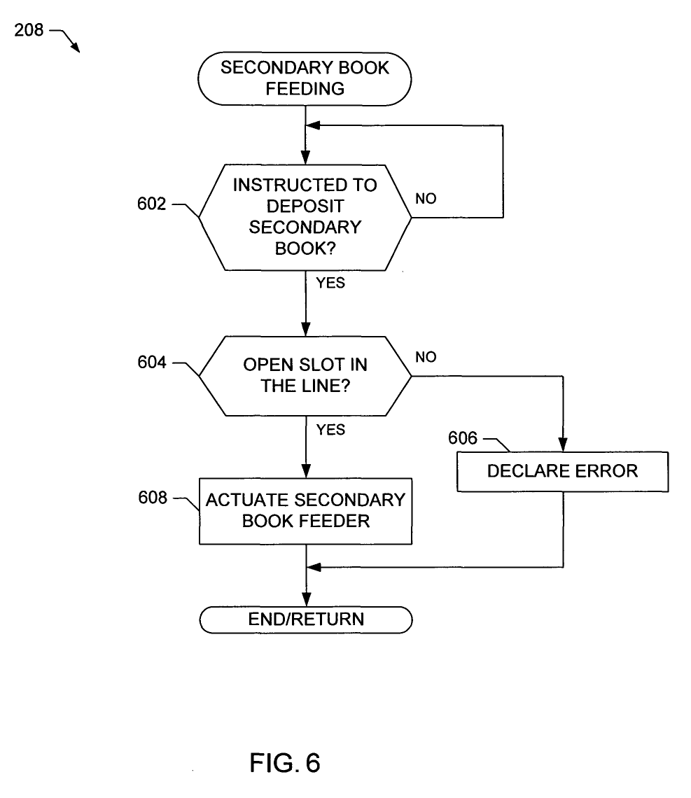

As shown in FIG. 6, the secondary book feeding process 208 waits until a secondary book is to be deposited (block 602). When a secondary book it to be deposited (block 602), it is determined if there is an open slot in the line below the secondary feeder 144-148 that is to deposit the secondary book on the line (block 604). If there is no open slot in the line corresponding to the secondary feeder 144-148 that is to deposit the secondary book (block 604), an error is declared (block 606) because the line has become unsynchronized. If, however, there is an open slot in the line (block 604), the secondary feeder 108 is actuated to deposit a secondary book 150-154 into the open slot in the line (block 608).

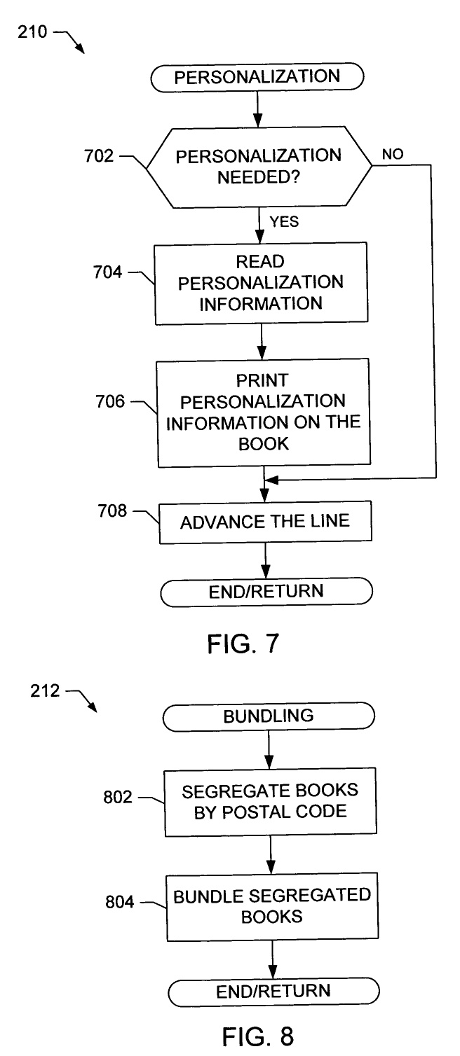

After the secondary book feeding process 208 has concluded, the book making process 200 executes a personalization process 210, which controls the printer 110 to print custom information onto the books on the mail table 142. In the example of FIG. 7, it is determined if a book below the printer 110 (either a primary book or a secondary book) requires personalization (block 702). Whether personalization is needed is determined by information in the database 162, as well as the book (or absence of a book) below the printer 110. For example, the database 162 may not specify any personalization information for a particular book, in which case nothing will be printed on the book below the printer 110.

If personalization is needed (block 702), the personalization information (e.g., the information to be imprinted on a book below the printer 110) is read from the database 162 (block 704) and is printed onto the book (block 706). Personalization information may include names and addresses, textual messages, graphics or any other suitable graphical information that may be printed onto a book by the printer 110.

After the personalization information is read and printed onto the book (blocks 704-706), the line is advanced (block 708), which places the next segment of the mailing table 142 below the printer 110. The segment of the mailing table that is advanced to be under the printer 110 may be a blank or gap containing no book or may be a subsequent book.

Conversely, if the book below the printer 110 does not require personalization (block 702), the line is advanced (block 708), which moves a subsequent mail table segment below the printer 110.

After the line has advanced (block 708), the process 210 ends and control returns to the process 200, which resumes execution at the bundling process 212, which, as shown in FIG. 8, segregates books by postal code (block 802) and bundles the segregated books (block 804). Because the books from the secondary source are inserted into open spaces in the line that follow primary books addressed to the same recipient as the recipient of the secondary books, the bundling carried out is, by definition, sorted. For example, if Jane Smith is designated in the database 162 as intended to receive a secondary book in addition to a primary book, a primary book addressed to Jane Smith will be followed on the line by a secondary book also addressed to Jane Smith.

While the foregoing describes the gathering section 102 as creating gaps in the line that are perpetuated by components of the system to create gaps in the line at the mail table 142, the gaps for secondary books could be created any number of other ways. For example, any of the system 100 components could be used to advance the line without providing a primary book component thereto. In particular, the trimmer 106 could be controlled to advance the line to make room in the line for one or more secondary books.

What is claimed is:

1. A method of assembling a mailing, the method comprising:
producing a stream of primary books on a production line;
determining that a secondary book is to be inserted between first and second primary books on the production line;
creating a space between first and second primary books on the production line; and
inserting the secondary book into the space between the first and second primary books on the production line.

2. A method as defined by claim 1, wherein the determination that a secondary book is to be inserted between the first and second primary books is made by examination of a database.

3. A method as defined by claim 2, wherein the database comprises a list of names and addresses.

4. A method as defined by claim 2, wherein the database comprises an indication of whether an addressee is to receive the secondary book.

5. A method as defined by claim 1, wherein the secondary book comprises any one of a number of books different from the stream of primary books.

6. A method as defined by claim 1, comprising printing information on the primary books and the secondary book.

7. A method as defined by claim 6, wherein the information printed on the primary books and the secondary books comprises addresses.

8. A method as defined by claim 7, wherein the secondary book and one of the first and second primary books comprise the same address.

9. A method as defined by claim 1, comprising printing information on the primary books.

10. A method as defined by claim 1, wherein producing a stream of primary books on the production line comprises gathering and stitching signatures.

11. A method as defined by claim 1, wherein the primary books are bound in a first manner and the secondary book is bound in a second manner different from the first manner.

12. A method as defined by claim 11, wherein the primary books are saddle stitched.

13. A method as defined by claim 12, wherein the secondary book is perfect bound.

14. An article of manufacture comprising a machine-accessible medium having a plurality of machine accessible instructions that, when executed, cause a machine to:
produce a stream of primary books on a production line;
determine that a secondary book is to be inserted between first and second primary books on the production line;
create a space between the first and second primary books on the production line; and
insert a secondary book into the space between the first and second primary books on the production line.

15. A machine-accessible medium as defined by claim 14, wherein the determination that a secondary book is to be inserted between the first and second primary books is made by examination of a database.

16. A machine-accessible medium as defined by claim 15, wherein the database comprises a list of names and addresses.

17. A machine-accessible medium as defined by claim 15, wherein the database comprises an indication of whether an addressee is to receive the secondary book.

18. A machine-accessible medium as defined by claim 14, wherein the secondary book comprises any one of a number of books different from the stream of primary books.

19. A machine-accessible medium as defined by claim 14, wherein the plurality of machine accessible instructions, when executed, cause a machine to print information on the primary books and the secondary book.

20. A machine-accessible medium as defined by claim 19, wherein the information printed on the primary books and the secondary books comprises addresses.

21. A machine-accessible medium as defined by claim 20, wherein the secondary book and one of the first and second primary books comprise the same address.

22. A machine-accessible medium as defined by claim 14, wherein the primary books are bound in a first manner and the secondary book is bound in a second manner different from the first manner.

23. A method of assembling a mailing on a production line, the method comprising:
gathering signatures for a primary book at a first stage of the production line;
binding the signatures of the primary book in a first manner at a second stage of the production line;
trimming the primary book at a third stage of the production line;
feeding a complete secondary book bound in a second manner different from the first manner onto the production line at a location behind the primary book; and
printing information on at least one of the primary book and the secondary book.

24. A method as defined by claim 23 comprising determining that the secondary book is to be inserted after the primary book.

25. A method as defined by claim 24, wherein the determination that a secondary book is to be inserted after the primary book is made by examination of a database.

26. A method as defined by claim 25, wherein the database comprises a list of names and addresses.

27. A method as defined by claim 25, wherein the database comprises an indication of whether an addressee is to receive the secondary book.

28. A method as defined by claim 23, wherein the secondary book is fed onto the production line at a location adjacent the primary book.

29. A method as defined by claim 23, comprising printing personalized information on the primary book and the secondary book.

30. A method as defined by claim 29, wherein the personalized information printed on the primary book is identical to the personalized information printed on the secondary book.

31. A method as defined by claim 30, wherein the personalized information comprises an address.

32. A method as defined by claim 23, wherein the primary book is saddle stitch bound.

33. A method as defined by claim 32, wherein the secondary book is perfect bound.

34. An article of manufacture comprising a machine-accessible medium having a plurality of machine accessible instructions that, when executed, cause a machine to:
gather signatures for a primary book at a first stage of the production line;
bind the signatures of the primary book in a first manner at a second stage of the production line;
trim the primary book at a third stage of the production line;
feed a complete secondary book bound in a second manner different from the first manner onto the production line at a location behind the primary book; and
print information on at least one of the primary book and the secondary books.

35. A machine-accessible medium as defined by claim 34 comprising determining that the secondary book is to be inserted after the primary book.

36. A machine-accessible medium as defined by claim 35, wherein the determination that a secondary book is to be inserted after the primary book is made by examination of a database.

37. A machine-accessible medium as defined by claim 35, wherein the database comprises a list of names and addresses.

38. A machine-accessible medium as defined by claim 35, wherein the plurality of machine accessible instructions, when executed, cause a machine to feed the secondary book onto the production line at a location adjacent the primary book.

39. A machine-accessible medium as defined by claim 34, wherein the plurality of machine accessible instructions, when executed, cause a machine to print personalized information on the primary book and the secondary book.

40. A machine-accessible medium as defined by claim 39, wherein the personalized information printed on the primary book is identical to the personalized information printed on the secondary book.

41. A machine-accessible medium as defined by claim 40, wherein the personalized information comprises an address.

42. A machine-accessible medium as defined by claim 34, wherein the primary book is saddle stitch bound.

43. A machine-accessible medium as defined by claim 34, wherein the secondary book is perfect bound.

44. A book making system comprising:
a gathering section configured to gather signatures at a first station on a processing line;
a stitcher configured to receive gathered signatures and to bind the gathered signatures to make primary books at a second station on the processing line;
a secondary book feeder configured to selectively commingle secondary books with the primary books at a third station on the processing line; and
a printer configured to personalize the primary books and the secondary books.

45. A book making system as defined by claim 43, wherein the secondary book feeder is configured to commingle the secondary books with the primary books by inserting a secondary book onto the processing line at a position adjacent a primary book intended for the same addressee.

46. A book making system as defined by claim 43, wherein the personalization of the primary books and the secondary books comprises addressing the primary books and the secondary books.

47. A book making system as defined by claim 43, wherein the secondary books comprise a number of books other than the primary book.

48. A book making system as defined by claim 43, wherein the primary book is bound in a first manner and the secondary book is bound in a second manner different from the first manner.

49. A book making system as defined by claim 43, wherein the primary book is saddle stitched.

50. A book making system as defined by claim 43, wherein the secondary book is perfect bound.
